(19) United States
(12) Patent Application Publication
(10) Pub. No.: US 2025/0307701 A1
(43) Pub. Date: Oct. 2, 2025

(54) METHODS AND APPARATUS TO DETECT AN ELECTRICAL ARC USING MACHINE LEARNING

(71) Applicant: Texas Instruments Incorporated, Dallas, TX (US)

(72) Inventors: Adithya Thonse, Bengaluru (IN); Aravindhan Karuppiah, Bengaluru (IN)

(21) Appl. No.: 18/638,141

(22) Filed: Apr. 17, 2024

Related U.S. Application Data
(60) Provisional application No. 63/573,255, filed on Apr. 2, 2024.

(51) Int. Cl. G06N 20/00

(52) U.S. Cl. CPC G06N 20/00

(57) ABSTRACT

Systems, apparatus, articles of manufacture, and methods for detection of an electrical arc using machine learning are described. Example instructions, when executed, cause at least one processor circuit to at least access data representing at least one of a voltage or a current of a monitored circuit, execute a machine learning model using the data to generate a classification representative of whether an arc has occurred within the monitored circuit, cause output of the result of the classification of whether the arc has occurred within the monitored circuit, record the data from the monitored circuit, and perform additional training of the machine learning model based on the recorded data.

### RELATED APPLICATIONS

This application hereby claims the benefit of and priority to U.S. Provisional Patent Application 63/573,255, titled “Methods and Apparatus to Detect an Electrical Arc Using Machine Learning,” filed Apr. 2, 2024, which is hereby incorporated by reference in its entirety.

### TECHNICAL FIELD

This description relates generally to fault detection and, more particularly, to methods and apparatus to detect an electrical are using machine learning.

### BACKGROUND

In power and photovoltaic grids, direct-current DC series arc faults can lead to inefficiency and are a cause of fire hazards and, as a result, system downtime. These faults can occur due to a number of reasons including poor insulation material, chipping off of insulation, broken wires, etc. Sustained DC arcing can, in some instances, cause fires and other dangerous conditions. If the arc can be detected and the circuit cutoff before the arc is sustained, damage to components and other dangerous conditions can be avoided.

### SUMMARY

A system of one or more circuits and/or computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an apparatus for detection of electrical arcs. The apparatus also includes sampling circuitry to access data representing at least one of a voltage or a current of a monitored circuit. The apparatus also includes memory. The apparatus also includes machine-readable instructions. The apparatus also includes at least one processor circuit to be programmed by the machine-readable instructions to: execute a machine learning model using the data to generate a classification representative of whether an arc has occurred within the monitored circuit, cause output of a result of the classification of whether the arc has occurred within the monitored circuit, record the data from the monitored circuit in the memory, and perform additional training of the machine learning model based on the data recorded in the memory. Other embodiments of this aspect include corresponding computer systems, apparatus, and computer programs recorded on one or more computer storage devices, each configured to perform the actions of the methods.

One general aspect includes at least one non-transitory machine-readable medium may include machine-readable instructions to cause at least one processor circuit to at least access data representing at least one of a voltage or a current of a monitored circuit. The instructions also cause the at least one processor circuit to execute a machine learning model using the data to generate a classification representative of whether an arc has occurred within the monitored circuit. The instructions also cause the at least one processor circuit to cause output of a result of the classification of whether the arc has occurred within the monitored circuit. The instructions also cause the at least one processor circuit to record the data from the monitored circuit. The instructions also cause the at least one processor circuit to perform additional training of the machine learning model based on the recorded data. Other embodiments of this aspect include corresponding computer systems, apparatus, and computer programs recorded on one or more computer storage devices, each configured to perform the actions of the methods.

One general aspect includes a method for detection of an electrical arc. The method also includes accessing data representing at least one of a voltage or a current of a monitored circuit. The method also includes executing a machine learning model using the data to generate a classification representative of whether an arc has occurred within the monitored circuit. The method also includes causing output of a result of the classification of whether the arc has occurred within the monitored circuit. The method also includes recording the data from the monitored circuit. The method also includes performing, using at least one logic circuit, additional training of the machine learning model based on the recorded data. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a flowchart representative of a prior art approach for detection of an electrical arc.

FIG. 2 is a block diagram of an example implementation of arc detection circuitry for detection of an electrical arc using deep learning.

FIG. 3 is a block diagram of an example implementation of model trainer circuitry that is to generate a model for use by the arc detection circuitry of FIG. 2.

FIG. 4 is a flowchart representative of example machine readable instructions and/or example operations that may be executed, instantiated, and/or performed by example programmable circuitry to implement the arc detection circuitry of FIG. 2 to perform arc detection using a machine learning model.

FIG. 5 is a flowchart representative of example machine readable instructions and/or example operations that may be executed, instantiated, and/or performed by example programmable circuitry to implement the model trainer circuitry of FIG. 3 to train and distribute the machine learning model to the arc detection circuitry of FIG. 2.

FIG. 6 is a flowchart representative of example machine readable instructions and/or example operations that may be executed, instantiated, and/or performed by example programmable circuitry to implement the arc detection circuitry of FIG. 2 to perform additional local training of the machine learning model.

FIG. 7 is a diagram illustrating an example architecture of the machine learning model used by the arc detection circuitry of FIG. 2.

FIG. 8 is a table illustrating differences between sampled and down-sampled approaches.

FIG. 9 is an illustration including tables representing performance statistics when the machine learning model utilized by the arc detection circuitry of FIG. 2 is trained using various training data.

FIG. 10 is a block diagram of an example processing platform including programmable circuitry structured to execute, instantiate, and/or perform the example machine readable instructions and/or perform the example operations of FIGS. 4 and/or 6 to implement the arc detection circuitry of FIG. 2.

FIG. 11 is a block diagram of an example processing platform including programmable circuitry structured to execute, instantiate, and/or perform the example machine readable instructions and/or perform the example operations of FIG. 5 to implement the model trainer circuitry of FIG. 3.

FIG. 12 is a block diagram of an example implementation of the programmable circuitry of FIG. 10 or 11.

FIG. 13 is a block diagram of another example implementation of the programmable circuitry of FIG. 10 or 11.

FIG. 14 is a block diagram of an example software/firmware/instructions distribution platform (e.g., one or more servers) to distribute software, instructions, and/or firmware (e.g., corresponding to the example machine readable instructions of FIGS. 4, 5, and/or 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Arcing, also known as sparking or arc discharge, is a phenomenon that occurs when an electric current passes through the air or other medium, instead of following its intended path along conductive materials within an electrical circuit. This can happen due to various reasons such as insulation failure, high voltage, and gaps in the conductor.

In arcing, electrons jump across the gap between two conductors or from a conductor to another object, creating a visible spark or arc discharge. The process involves the flow of electric current through ionized air particles, which causes them to heat up and emit light. This can be observed in various electrical devices like switches, relays, and arcing faults in circuits. Arcing is generally undesirable as it may lead to overheating, fire hazards, or damage to the circuit components. To prevent arcing, proper insulation materials are used, and appropriate safety measures are implemented within electrical systems, such as example approaches described herein.

Arcing can occur in both Alternating Current (AC) and Direct Current (DC) circuits. Detection and/or mitigation of DC arcing is typically more challenging than in AC scenarios, as there is no zero crossing in DC circuits (which can be helpful in extinguishing an arc). DC arcing can occur in photovoltaic plants (PV), electric vehicles (EV), more electric aircraft (MEA), and DC microgrids, including servers.

For example, in PV systems, solar panels are used to generate Direct Current (DC) electricity from sunlight. Arcing in such systems can be caused by factors like insulation failure or high voltage in the wiring or other circuitries. Prevention and/or mitigation of arcing in these PV plants is important, as such arcing may lead to reduced efficiency and damage to the PV system components. Example approaches for detection of arching in a PV system are described in U.S. Patent Application Publication No. 2012/0316804, which is incorporated by reference in its entirety.

In EVs, battery packs are used to store Direct Current (DC) electricity that powers electric motors. Arcing can occur due to high voltage or other failure(s) in the wiring or connectors of these vehicles. Preventing arcing is crucial for maintaining vehicle safety and efficiency.

In More Electric Aircrafts (MEAs), MEAs are designed with a focus on reducing weight, improving fuel efficiency, and increasing reliability by using electrical systems, instead of traditional hydraulic or pneumatic components. Arcing in these aircraft can occur and cause damage or other dangerous situations.

In data centers, microgrids with Direct Current (DC) power distribution are becoming increasingly popular due to their efficiency benefits. Arcing can occur within these systems and cause damage to computing equipment and/or cause system downtime. Preventing arcing in such setups is vital for maintaining the reliability and performance of servers and other critical equipment.

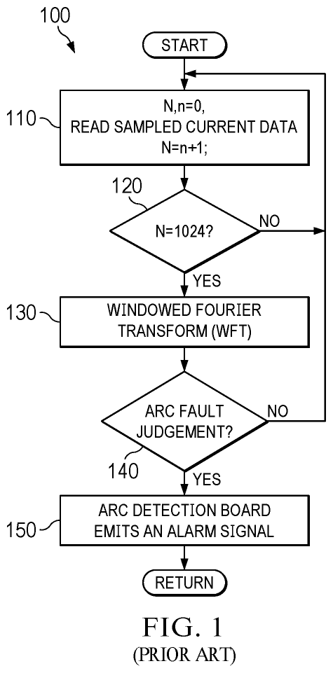

FIG. 1 is a flowchart representative of a prior art approach for detection of an electrical arc. In the approach illustrated in FIG. 1, the process 100 begins at block 110, where sampled current data is read from an electrical system. (Block 110). The reading of sampled data is continued until a sufficient number of samples (e.g., 1024 samples) have been collected to enable a windowed Fourier transform analysis (WFT). (Block 120). If sampled data is not sufficient (e.g., fewer than 1024 samples have been collected, resulting in block 120 returning a result of NO), the process returns to block 110 to collect additional samples.

Once adequate samples have been collected (e.g., block 120 returns a result of YES), a windowed Fourier transform is performed on the sampled data. (Block 130). A result of the WFT analysis is analyzed to determine whether an arc is detected. (Block 140). If an arc is detected (e.g., block 140 returns a result of YES), an alarm will be emitted notifying another entity (e.g., a circuit, a user) about the arcing event. If no arc fault is detected at block 140 (e.g., block 140 returns a result of NO), additional samples and/or analysis is performed.

The example approach of FIG. 1 focuses on using Windowed Fourier Transform (WFT) for detection of arcing events. Such an approach samples a circuit, e.g., at 250 kHz, in a time-domain environment. This approach is based on responsiveness to changes in frequency spectrum of the current signal, and involves breaking the input waveform into smaller windows or segments before applying Fast Fourier Transforms (FFT) analysis on each segment.

Although an Fourier Transform-based approach can be useful for detecting arcs, such an approach has several limitations such as its dependency on environment tuning and inverter frequency, lack of capability to learn as the system ages, and poor performance in noisy scenarios. The prior art system has limited accuracy for catching an arc fault, as the approach relies solely on responsiveness to changes in the frequency spectrum of the time-domain signal. Moreover, because samples are collected at a high sampling frequency (e.g., 250 kHz) and large windows (e.g., 1024 samples) are used, the analysis of this information involves significant computational overhead.

Example approaches described herein utilize machine learning for identifying arcing events. Such approaches provide a balance between input data resolution and system configuration complexity (e.g., computational complexity). Such approaches involve execution of a machine learning model based on various input data points to detect arcing. In examples described herein, downsampling/subsampling is utilized to enable generation of multiple points in the complexity vs accuracy space, enabling selection of an appropriate resolution and/or model size for the task at hand.

To improve generalization capabilities, example approaches described herein involve training using noisy data and handling multiple types of inputs (e.g., various combinations of voltages and currents). This ensures better performance across different product specifications.

Furthermore, the examples described herein enable aging scenarios to be handled by retraining the machine learning model, when necessary. As a system under observation ages, electrical characteristics may change, potentially affecting arc detection capabilities. By enabling retraining of the model, the model can adapt and maintain accuracy in such situations.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data (e.g., voltage data, current data, etc.) such that other input(s) result in output(s) consistent with the recognized patterns and/or associations.

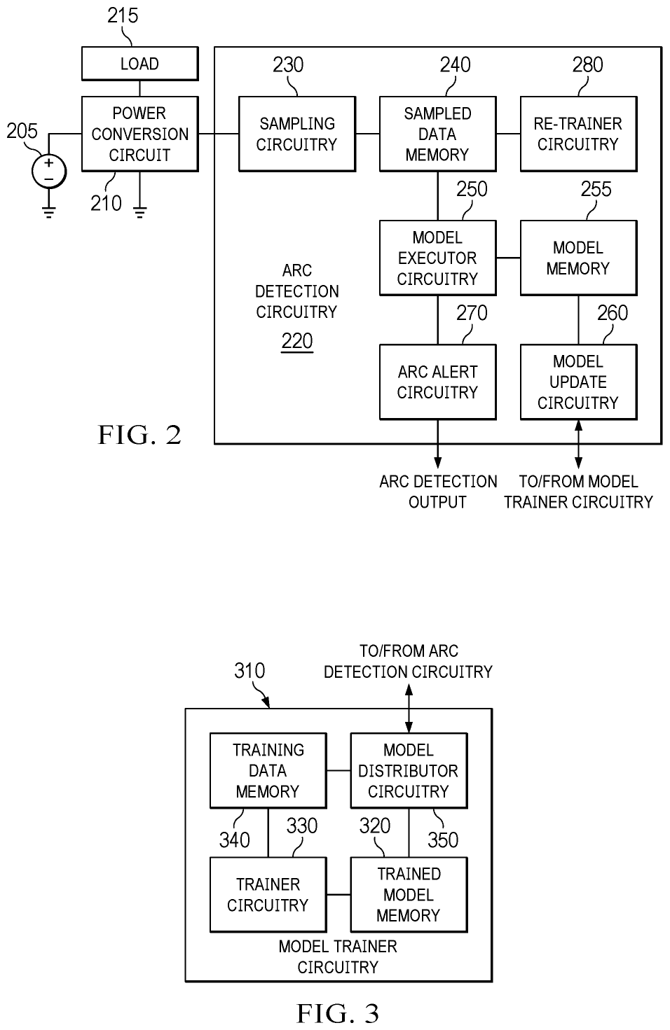

Many different types of machine learning models and/or machine learning architectures exist. In examples described herein, a neural network model is used. Using a neural network model enables efficient computation to be performed on low-powered computing devices, such as arc detection circuitry (e.g., arc detection circuitry 230 of FIG. 2) residing closely to a monitored circuit (e.g., power conversion circuit 210 of FIG. 2). In general, machine learning models/architectures that are suitable to use in the example approaches described herein will be small in their computational requirements. However, other types of machine learning models could also or alternatively be used.

In general, implementing a ML/AI system involves two phases, a learning/training phase, and an inference phase. In the learning/training phase, a training algorithm is used to train a model to operate using patterns and/or associations based on, for example, training data. As explained below, model trainer circuitry (e.g., the model trainer circuitry 310 of FIG. 3) may be utilized to perform training of a machine learning model that is to be distributed to arc detection circuitry (e.g., the arc detection circuitry 220 of FIG. 2) for use in an inference phase. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples described herein, ML/AI models are trained using stochastic gradient descent (SGD). However, any other training algorithm may also or alternatively be used. In examples described herein, training is performed until an acceptable level of error is achieved when evaluating test data. In examples described herein, training is performed at model trainer circuitry (e.g., a computing device separate from arc detection circuitry 220 that is to utilize the trained model to detect an arc). Training is performed using hyperparameters that control how the learning is performed (e.g., a learning rate, a number of layers to be used in the machine learning model, etc.). In some examples re-training may be performed. Such re-training may be performed based on a variety of conditions, e.g., in response to detection of an arc, an external trigger (e.g., a user request), a threshold period of time elapsing (e.g., where an arc has not been detected), etc. In some examples, the re-training may be performed locally at the arc detection circuitry itself (e.g., rather than at the model trainer circuitry where the model was initially trained). This local re-training may be performed on-chip, in some examples without communicating training data to/from an external computing system. Such an approach enables devices in the field to adapt to their local conditions and more accurately detect an arc event.

Training is performed using training data. In examples described herein, the training data originates from samples collected at arc detection circuitry (e.g., a device operating in the field). When supervised training is used, the training data is labeled (e.g., labeling arcing events). Labeling is applied to the training data based on detected arcing events. Such detected events may be identified by hand (e.g., an operator may curate the data), based on arcing that is triggered under controlled conditions, etc.

Once training is complete, the model is deployed for use as an executable construct that processes an input and provides an output based on the network of nodes and connections defined in the model. The model is stored in a memory of arc detection circuitry (e.g., the arc detection circuitry of FIG. 2), and may be executed locally by such arc detection circuitry to perform arc detection.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, retraining of the model can be triggered using the feedback and an updated training data set, hyperparameters, etc., to generate an updated, deployed model.

FIG. 2 is a block diagram of an example implementation of arc detection circuitry 220 to monitor a monitored circuit (e.g., a power conversion circuit 210, a load 215, etc.).

Arc detection circuitry 220 may be an edge device that can be deployed in the field to detect arcs. In other words, arc detection circuitry 220 resides closely to power conversion circuit 210. For example, arc detection circuitry 220 may be integrated into the control circuitry of power conversion circuit 210, both installed on the same premise. In some examples, arc detection circuitry 220 is configurable to detect arcs and perform re-training on-chip without communicating sampled data or training data to a remote system, e.g., a cloud-based computing system. Arc detection circuitry 220 may be configured to couple to a sensor (e.g., voltage sensor, current sensor, magnetoresistive sensor, etc.). Additionally or alternatively, arc detection circuitry 220 may include one or more sensors that are integrated into the arc detection circuitry 220 or provided as external components coupled to arc detection circuitry 220. As an example, the data sampling/acquisition, data processing, model execution, and additional training may all be performed by the arc detection circuitry 220 alone, instead of using or relying on a cloud-based remote component. Some implementations of arc detection circuitry 220 (e.g., initial training of the neural network model) can transmit and receive data with an external computing system (e.g., a cloud-based system, model trainer circuitry, a separate computing system, etc.), but performing detection and/or re-training fully on-chip or partially on-chip can reduce power consumption, processing overhead, latency, and bandwidth, as compared to a cloud-based approach.

In the illustrated example of FIG. 2, a DC power supply 205 provides electricity to a power conversion circuit 210, which then converts electricity from DC to AC to drive a load 215. The example power conversion circuit 210 is monitored by architecture and circuitry 220 to enable detection of an electrical arc. Additionally or alternatively, the arc detection circuitry 220 may be configured to monitor other components in the system to detect an arc in the power supply 205, the load 215, the electrical connection between the power supply 205 and the power conversion circuit 210, and/or the electrical connection between the power conversion circuit 210 and the load 215. The example arc detection circuitry 220 includes sampling circuitry 230, sample data memory 240, model executor circuitry 250, model memory 255, model update circuitry 260, arc alert circuitry 270, and re-trainer circuitry 280. In operation, sampling circuitry 230 generates and stores samples in the sample data memory 240. The samples stored in sample data memory 240 are evaluated by the model executor circuitry 250 based on a trained model stored in the model memory 255. In response to the model executor circuitry to 250 detecting the arc, the arc alert circuitry 270 outputs an indication that the arc has been detected. Such an indication may be utilized to, for example, cause the power conversion circuitry 210 to be reset and/or disabled, thereby preventing damage that might occur as a result of the detected arc.

The example power supply 205 of the illustrated example of FIG. 2 is represented as a DC power supply. However, in some examples, the example power supply 205 may be implemented using an AC power supply. The example power supply 205 may represent different power supply technologies based on the context in which the example system of FIG. 2 is to implement. For example, in a photovoltaic system, the power supply 205 may represent photovoltaic panels that convert light into electrical energy, and the load 215 may represent a battery or electrical grid. Alternatively, in an electric vehicle (EV) scenario, the example power supply 205 may represent one or more batteries in the EV that provide stored electrical energy to the load 215 (e.g., a motor) in the EV. In another EV scenario, the power supply 205 represents the electrical grid, and the load 215 represents the one or more batteries in the EV.

The example power conversion circuit 210 of the illustrated example of FIG. 2 converts the electrical energy provided by the power supply into a level that is acceptable for use by the load 215. For example, the voltage provided by the power supply may be presented to the power conversion circuit 210 at a level of 400 volts, whereas the load 215 operates using 12 volts. Such power conversion therefore enables the load 215 to operate at the expected level. The example power conversion circuit 210 may be implemented using, for example, a buck converter, a boost converter, a transformer, and/or any other circuitries capable of converting power from one level to another. Examples described herein, the sampling circuitry 230 monitors the power conversion circuit 210 for arcing. Thus, in examples described herein, the power conversion circuit 210 may be more generally referred to as a monitored circuit. While examples described herein describe monitoring of power conversion circuit, any other circuitry may also or alternatively be monitored for the presence to detect arcing. For example, the load 215 may represent the monitored circuit in addition to, or as an alternative to, the power conversion circuit 210.

The example load 215 of the illustrated example of FIG. 2 receives power from the power conversion circuit 210. The load 215 may therefore be implemented by any sort of electrical device. In some examples, the load 215 may receive power directly from the power supply 205 (e.g., without the use of the power conversion circuit 210.) In such an example, the sampling circuitry 230 may monitor the load 215. That is, the load 215 may be more generally referred to as the monitored circuit (e.g., in addition or as an alternative to the power conversion circuit 210).

The example sampling circuitry 230 of the illustrated example of FIG. 2 sampling circuitry 230 samples a monitored circuit. The example monitored circuit may be, for example, the power conversion circuit 210, the load 215, or any other circuit that is to be monitored. In examples described herein, the sampling circuitry 230 monitors voltage levels of the monitored circuit. However, any other electrical characteristic of the monitored circuit may also or alternatively be recorded. For example, the sampling circuitry 230 may monitor current levels or both voltage and current levels of the monitored circuit. In some examples, the sampling circuitry 230 operates at a sampling frequency of 3 kHz. Such a frequency is lower than the frequency of the prior art systems. Because of the lowered frequency, computing resources required to analyze the data are reduced, enabling multiple monitored circuits to be monitored at once, enabling low-power computing circuitry to be used to analyze the sampled data, etc.

In some examples, the arc detection circuitry 220 includes means for sampling. For example, the means for sampling may be implemented by the sampling circuitry 230. In some examples, the sampling circuitry 230 may include one or more voltage sensors, current sensors, signal conditioning and filtering circuits, analog-to-digital converters, etc. Once the sampling circuitry 230 generates samples from the monitored circuit, the sampling circuitry 230 may convert the samples into digital values to store in sampled data memory 240.

The example sampled data memory 240 of the illustrated example of FIG. 2 stores samples collected by the sampling circuitry 230. The example sampled data memory 240 of the illustrated example of FIG. 2 is implemented by any memory, storage device, and/or storage disc for storing data such as, for example, flash memory, magnetic media, optical media, solid state memory, hard drive(s), thumb drive(s), etc. Furthermore, the data stored in the example sampled data memory 240 may be in any data format such as, for example, binary data, comma delimited data, tab delimited data, structured query language (SQL) structures, etc. While, in the illustrated example, the sampled data memory 240 is illustrated as a single device, the example sampled data memory 240 and/or any other data storage devices described herein may be implemented by any number and/or type(s) of memories. In some examples, the sampled data memory 240 may be implemented as a circular buffer. Moreover, in some examples, data stored in the sampled data memory may be provided to the model trainer circuitry 310 of FIG. 3 for training of a machine learning model.

When executing machine learning model using the sampled data, the example model executor circuitry 250 of the illustrated example of FIG. 2 determines whether the amount of data stored in the sample data memory 240 is sufficient for performing analysis. In examples described herein, the model executor circuitry 250 determines that sample data is sufficient when at least 750 samples are stored in the sample data memory. At a sampling frequency of 3 kHz, these 750 samples represent approximately 250 milliseconds (ms) of sample data that will be analyzed by the model executor circuitry. However, any other threshold may alternatively be used. If the example model executor circuitry 250 determines that the amount of sample data is sufficient, the example model executor circuitry 250 executes the machine learning model stored in the model memory 255 using the sampled data.

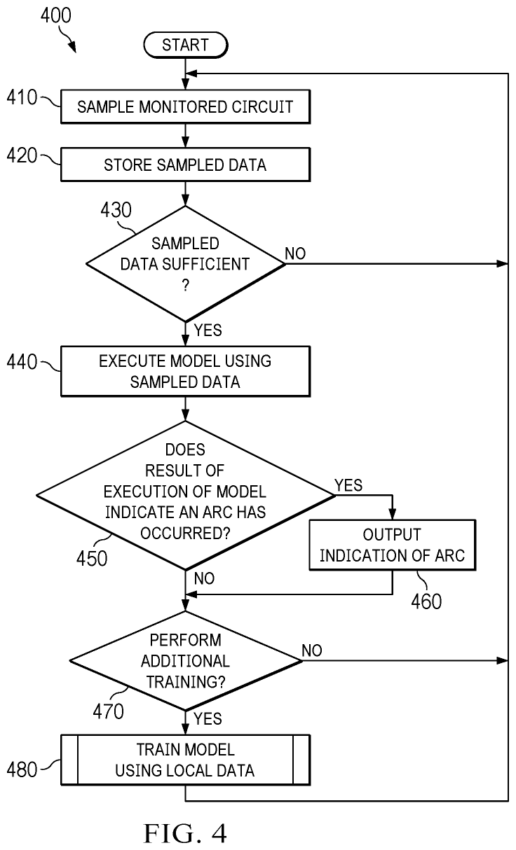

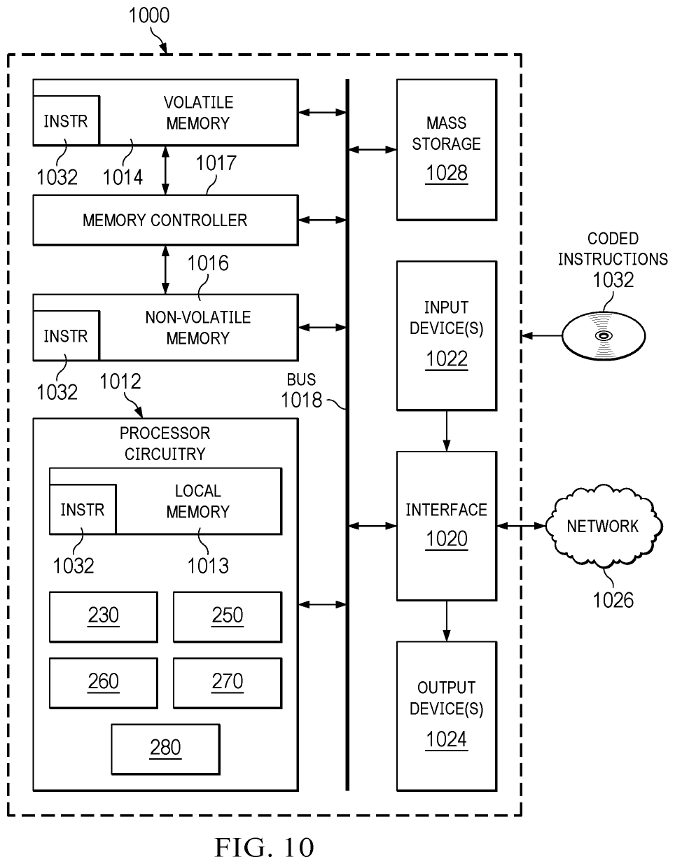

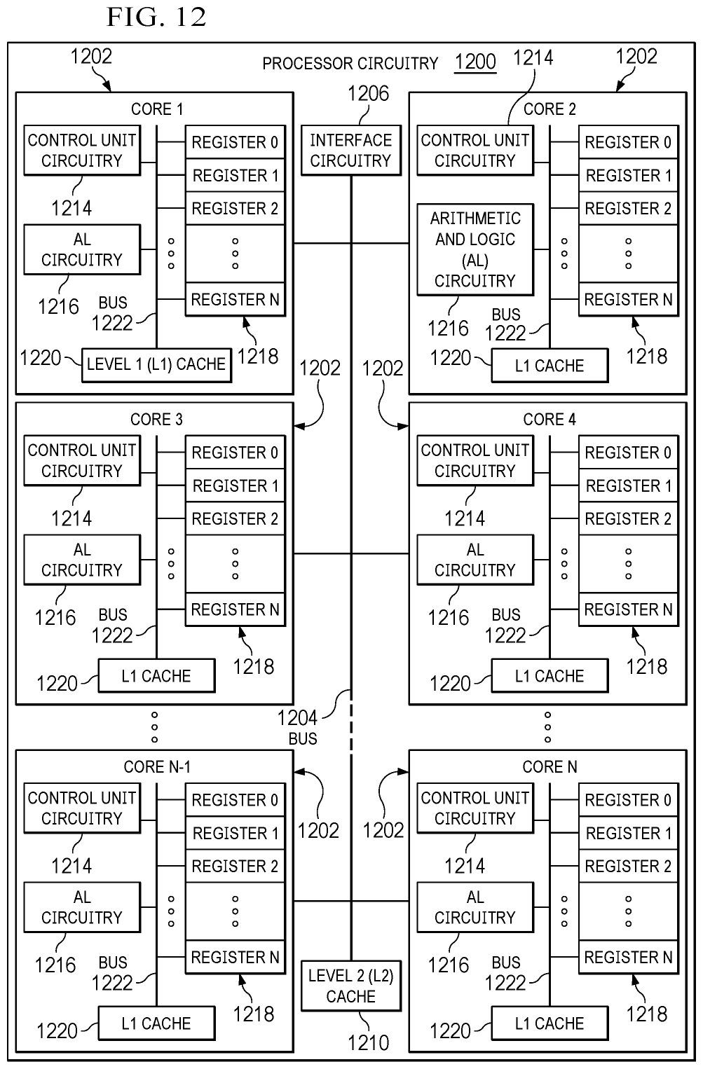

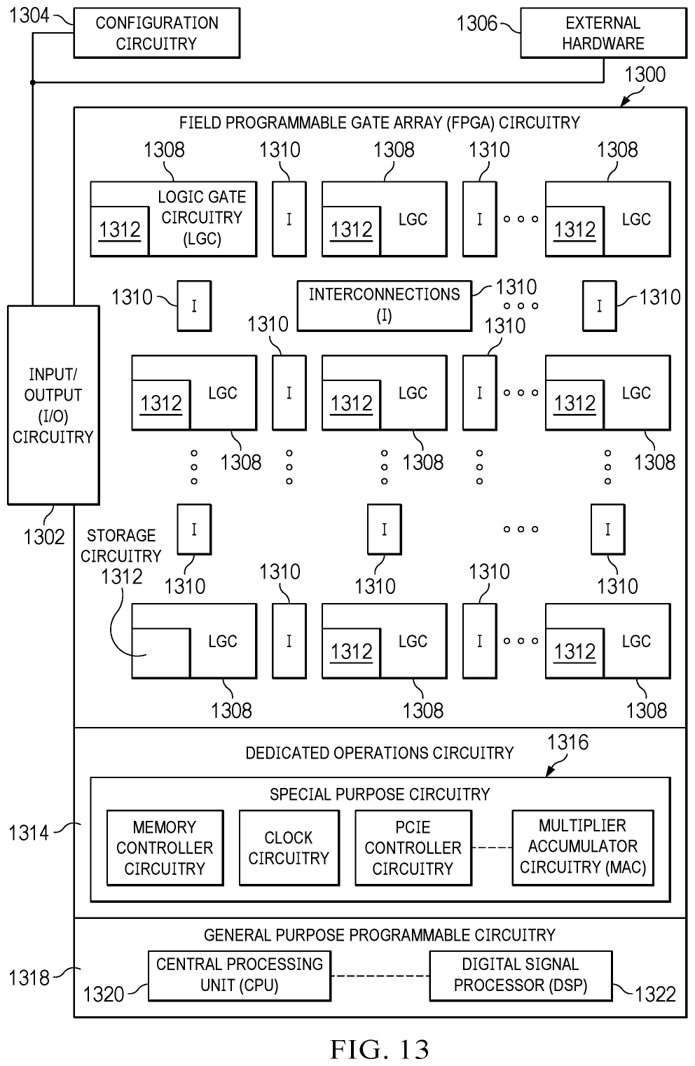

In some examples, the arc detection circuitry 220 includes means for executing a machine learning model. For example, the means for executing a machine learning model may be implemented by model executor circuitry 250. In some examples, the model executor circuitry 250 may be instantiated by programmable circuitry such as the example programmable circuitry 1012 of FIG. 10. For instance, the model executor circuitry 250 may be instantiated by the example microprocessor 1200 of FIG. 12 executing machine executable instructions such as those implemented by at least blocks 430, 440 of FIG. 4. In some examples, the model executor circuitry 250 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the model executor circuitry 250 may be instantiated by any other combination of hardware, software, and/or firmware. For example, the model executor circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In examples described herein, the sampled data memory 240 may store a large size of data, and the example model executor circuitry 250 may prepare the sampled data by selecting a subset of the data stored in the sampled data memory 240. This subset may represent, for example, a most recent sampling window (e.g., the most recent seven hundred and fifty samples). In such an example, the sampled data memory 240 may store more samples than used by the model executor circuitry 250 when executing machine-learning model. For example, the sample data memory 240 may store one hundred thousand samples, whereas only the most recent seven hundred and fifty samples are used when executing the model. Those additional samples that are not used when executing the model may be useful when attempting to retrain the model using local data.

Additionally, the example model executor circuitry 250 determines whether to perform additional training of the model stored in the model memory 255. Such additional training may be performed on a periodic basis (e.g., after a threshold number of samples have been collected, after a threshold amount of time has elapsed, etc.), on an a-periodic basis (e.g., in response to a user request, in response to execution of the model indicating a low level of confidence in a result, etc.), or on both the a-periodic basis and the periodic basis. For example, the model executor circuitry 250 may be configurable to maintain a count of the number of samples collected and/or an elapsed time. The model executor circuitry 250 may be configurable to compare the count/time to a threshold value and initiate the additional training in response to the comparison. In this manner, the count/time may represent an amount of samples since a prior training or re-training, an amount of time since a prior training or re-training, etc.

The example model executor circuitry 250 may utilize other conditions to determine whether to perform re-training as well. For example, the model executor circuitry 250 may be configurable to receive a software/firmware update, which may include an indication that additional training should be performed. The model executor circuitry 250 may be configurable to perform additional training in response to receiving the software/firmware update and/or determining that the software/firmware update includes the indication that additional training should be performed.

In some examples, a confidence score may be generated by the model executor circuitry 250 as part of the attempt to detect whether an arc has occurred. For example, the model executor circuitry 250 may generate both an indication (e.g., a value) representing a likelihood that an arc has occurred, as well as a confidence in the likelihood value. As an example, the model executor circuitry 250 may generate a value indicating a high likelihood that an arc has occurred, but also generate a low confidence in the generation of the high likelihood. In such an example, the model executor circuitry 250 may compare the confidence value to a confidence threshold to determine whether to perform additional re-training (e.g., in order to raise the confidence of future arc detections).

Moreover, in some examples, an instruction from a remote/external source (e.g., a cloud-based computing service, the model trainer circuitry, etc.) may cause the model executor circuitry 250 to determine that re-training is to be performed. For example, instead of receiving the software/firmware update as noted above, an update instruction may be received from the remote/external source to cause the model executor to perform re-training. Alternatively, the instruction received from the remote/external source may update configuration parameters (e.g., a count threshold, a time threshold, a confidence, etc.) used by the model executor circuitry 250 to determine whether to perform the re-training.

While the example approaches for determining whether to perform re-training disclosed herein are described as individual logical choices of whether to re-train, in some examples, multiple logical conditions may be combined into various decision structures to determine whether to initiate re-training. For example, the example model executor circuitry 250 may determine that an external instruction to perform re-training has been received, but a threshold amount of time has not yet elapsed since a prior re-training of the model and, as a result, may not initiate re-training until the threshold amount of time has elapsed (e.g., until both conditions are true). Alternatively, the example model executor circuitry 250 may determine that re-training is to be performed in response to an amount of time having elapsed without the determination that the arc has occurred within the monitored circuit.

The example model memory 255 on the illustrated example of FIG. 2 stores one or more models for execution by the model executor circuitry 250. The example model memory 255 of the illustrated example of FIG. 2 is implemented by any memory, storage device and/or storage disc for storing data such as, for example, flash memory, magnetic media, optical media, solid state memory, hard drive(s), thumb drive(s), etc. Furthermore, the data stored in the example model memory 255 may be in any data format such as, for example, binary data, comma delimited data, tab delimited data, structured query language (SQL) structures, etc. While, in the illustrated example, the model memory 255 is illustrated as a single device, the example model memory 255 and/or any other data storage devices described herein may be implemented by any number and/or type(s) of memories. In examples described herein, the model stored in the model memory 255 may be locally re-trained by the re-trainer circuitry 280, or may be updated by the model update circuitry 260.

The example model update circuitry 260 of the illustrated example of FIG. 2 communicates with the example model trainer circuitry 310 of FIG. 3 to receive a trained model to be stored in the model memory 255. The model may then be executed by the model executor circuitry 250 to enable detection of an arc. The model may be subject to additional training, e.g., by re-trainer circuitry 280 based on a variety of conditions as described above. The additional training may generate an updated mode, which may further be stored in the model memory 255.

In some examples, the arc detection circuitry 220 includes means for communicating. For example, the means for communicating may be implemented by model update circuitry 260. In some examples, the model update circuitry 260 may be instantiated by programmable circuitry such as the example programmable circuitry 1012 of FIG. 10. For instance, the model update circuitry 260 may be instantiated by the example microprocessor 1200 of FIG. 12 executing machine executable instructions. In some examples, model update circuitry 260 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the model update circuitry 260 may be instantiated by any other combination of hardware, software, and/or firmware. For example, the model update circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example arc alert circuitry 270 of the illustrated example of FIG. 2 reviews a result of the execution of the machine learning model to determine whether the result indicates that an arc has occurred. In some examples, the model executor circuitry 250 may output the result in the format of a numeric value representing a likelihood that an arc has occurred. The example arc alert circuitry 270 may evaluate that output against a threshold to determine whether to report that an arc has occurred. In such an example, the threshold may be set to allow an operator (e.g., a user) to allow for tuning of the sensitivity of the detection of whether an arc has occurred. In some other examples, the model executor circuitry 250 may output a binary value indicating whether the arc has occurred or not. Such a binary value may be evaluated by the arc alert circuitry 270 to determine whether the result indicates that the arc has occurred.

After determining whether to output an indication of an arc (e.g., an indication that an arc has occurred), the example arc alert circuitry 270 outputs the indication of the arc. The indication of the arc may be in the form of a binary value (e.g., a light or sound indicating an arc has occurred), may be in the form of a message on a display, etc. The output of the indication of the arc may be provided to, for example, other circuitry to enable a remediating action to be taken (e.g., to shut down the monitored circuit, to reset the monitored circuit, etc.). In some examples, the indication of the arc is provided to an operator to allow the operator to intervene.

The example of re-trainer circuitry 280 of the illustrated example of FIG. 2 performs additional training of the model stored in the model memory 255 using data stored in the sampled data memory 240. As described above, the retraining may be enabled based on a variety of conditions, e.g., based on a periodic or a-periodic basis, in response to a user request, in response to execution of the model indicating a low level of confidence in a result, etc.), or on both the a-periodic basis and the periodic basis. Further, the re-trainer circuitry 280 may update only a partial portion of the model, instead of the entire model, to produce an updated machine learning model. For example, the example re-trainer circuitry 280 may update classification layers of the machine learning model, as opposed to updating other layers (e.g., layers related to feature detection). Using such an approach reduces the computational complexity of updating model parameters, such that retraining can be performed on lower power computing devices, such as the example arc detection circuitry 220.

Example approaches described herein do not need to re-train based on labeled data that represents arcing. Instead, just having data of normal operation is sufficient for re-training of the model. In some examples, an auto-encoder approach is used as part of this re-training. In other words, unsupervised learning may be utilized as part of the re-training process.

Auto-encoders are a type of artificial neural network that can be used to train and retrain machine learning models, particularly in situations where data is limited or noisy. An auto-encoder approach utilizes an encoder and a decoder, which work together to learn a compressed representation of the input data and then reconstruct it as closely as possible from this representation.

In the context of the re-trainer circuitry 280 of FIG. 2, auto-encoders can be employed for retraining when additional training is needed using local data. This could occur if accuracy or confidence in the current model predictions are not sufficient. The encoder would take the input data (sampled from a monitored circuit) and compress it into a latent representation, while the decoder attempts to reconstruct the original data as closely as possible based on this compressed information.

Utilizing such an approach, the example re-trainer circuitry 280 can perform additional local training of the model. Such re-training enables the arc detection circuitry to account for changes (e.g., degradation) in the monitored circuit over time.

As described above, in some examples, the re-trainer circuitry 280 is limited to performing re-training of particular portions (e.g., layers) of the model without altering other portions/layers of the model. That is, only some of the portions (e.g., layers, segments, sections, etc.) of the model may be modified/updated by way of the re-training. For example, the re-trainer circuitry 280 may re-train layers related to classification, and may avoid re-training of layers not related to classification (e.g., feature detection layers). The re-trainer circuitry 280 may be configurable to perform re-training/additional training on fewer than all of the layers in the model. As an example, the re-training circuitry 280 may be configurable to lock some of the layers (e.g., non-classification layers) and perform re-training on only the unlocked layers (e.g., the classification layers or only the final layer). This type of training on fewer than all of the layers can be referred to as locked training, where the locked layers are not altered/updated/modified (e.g., the locked layers retain their parameters) during the training. The re-training/additional training performed by re-training circuitry 280 may be local training without having to upload the data to a cloud network for cloud training.

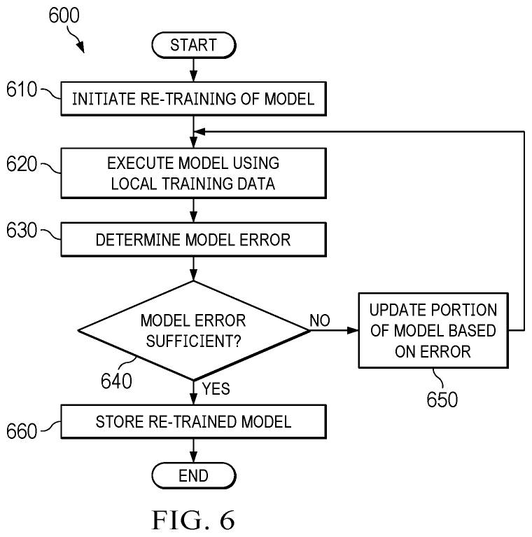

In some examples, the re-trainer circuitry 280 may be instantiated by programmable circuitry such as the example programmable circuitry 1012 of FIG. 10. For instance, the re-trainer circuitry 280 may be instantiated by the example microprocessor 1200 of FIG. 12 executing machine executable instructions such as those implemented by at least blocks 610, 620, 630, 640, 650, 660 of FIG. 6. In some examples, the re-trainer circuitry 280 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the re-trainer circuitry 280 may be instantiated by any other combination of hardware, software, and/or firmware. For example, the re-trainer circuitry 280 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of an example implementation of the model trainer circuitry 310 for training of a machine learning model for use by the arc detection circuitry 220. In some examples, the model trainer circuitry 310 may represent trainer circuitry in an external computing system (e.g., a cloud-based system, model trainer circuitry, a separate computing system, etc.) that performs an initial training of an arc detection machine learning model. For example, through communications the external computing system may receive samples acquired by in-field arc detection circuitry (e.g., arc detection circuitry 220), performs an initial training based on the samples to generate a trained arc detection model, and provide the trained model to the arc detection circuitry through communications. In some examples, the model trainer circuitry 310 may also represent re-trainer circuitry (e.g., re-trainer 280) in arc detection circuitry (e.g., arc detection circuitry 220) that performs local and in-field additional training to generate an updated arc detection machine learning model. The model trainer circuitry 310 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the model trainer circuitry 310 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In some examples, the model trainer circuitry 310 is instantiated by programmable circuitry executing training instructions and/or configured to perform operations such as those represented by the flowchart(s) of FIG. 4. The example model trainer circuitry 310 includes trained model memory 320, trainer circuitry 330, training data memory 340, and model distributor circuitry 350.

In the illustrated example of FIG. 3, the example trained model memory 320 stores trained models for distribution to the arc detection circuitry. In some examples, multiple different models may be trained based on different input data. For example, a first model may be trained based on input data rated at 400 volts, whereas a second model may be trained based on input data rated at 200 volts. Various combinations of input training data may be used.

The example trainer circuitry 330 of the illustrated example of FIG. 3 augments the labeled training data. In some examples, the training data may be collected from a relatively noise environment. For example, the training data may be acquired from during operations of a relatively low-voltage power conversion system, where the low voltage and power conversion may create noise to current and voltage signals. In some examples, the example trainer circuitry 330 may add noise to the training data. The noise improves results in improved model accuracy, as the noise-augmented training data more closely resembles various samples that may occur in practice. The example trainer circuitry 330 performs training of a machine learning model by executing the model using the training data, and evaluating an amount of error. The example trainer circuitry 330 determines whether the amount of error is sufficient. For example, model error may be considered sufficient when it is less than a threshold amount of acceptable error (e.g., less than 1% error, less than 5% error, etc.). If the model error is not sufficient, the example trainer circuitry 330 updates the model based on the amount of detected error. Additionally, in some examples, the example trainer circuitry 330 may track the amount time of the training and determine whether the training has been performed for a threshold duration. Based on the error and/or training time, the example trainer circuitry 330 may end the training of the machine learning model.

In some examples, the architecture of the model (e.g., the arrangement and/or sizes of layers) is modified during the training process. However, in some other examples, the architecture of the model is not changed during the training process. The training process performed by the example trainer circuitry 330 continues until continues until an acceptable amount of model error is achieved.

In the illustrated example of FIG. 3, the example training data memory 340 stores training data received from the arc detection circuitry 220. The example model distributor circuitry 350 of the illustrated example of FIG. 3 distributes the model to the arc detection circuitry 220. The example model update circuitry 260, upon receiving the updated model from the model distributor circuitry 350, may store the updated model in the model memory 255 for subsequent use by the model executor circuitry 250.

While an example manner of implementing the arc detection circuitry 220 is illustrated in FIG. 2, one or more of the elements, processes, and/or devices illustrated in FIG. 2 may be combined, divided, re-arranged, omitted, eliminated, and/or implemented in any other way. Further, the example sampling circuitry 230, the example model executor circuitry 250, the example model update circuitry 260, the example arc alert circuitry 270, the example re-trainer circuitry 280, and/or, more generally, the example arc detection circuitry 220 of FIG. 2, may be implemented by hardware alone or by hardware in combination with software and/or firmware. Thus, for example, any of the example sampling circuitry 230, the example model executor circuitry 250, the example model update circuitry 260, the example arc alert circuitry 270, the example re-trainer circuitry 280, and/or, more generally, the example arc detection circuitry 220, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example arc detection circuitry 220 of FIG. 2 may include one or more elements, processes, and/or devices in addition to, or instead of, those illustrated in FIG. 2, and/or may include more than one of any or all of the illustrated elements, processes and devices.

While an example manner of implementing the model trainer circuitry 310 of FIG. 1 is illustrated in FIG. 3, one or more of the elements, processes, and/or devices illustrated in FIG. 3 may be combined, divided, re-arranged, omitted, eliminated, and/or implemented in any other way. Further, the example trainer circuitry 330, the example model distributor circuitry 350, and/or, more generally, the example model trainer circuitry 310 of FIG. 3, may be implemented by hardware alone or by hardware in combination with software and/or firmware. Thus, for example, any of the example trainer circuitry 330, the example model distributor circuitry 350, and/or, more generally, the example model trainer circuitry 310, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example model trainer circuitry 310 of FIG. 3 may include one or more elements, processes, and/or devices in addition to, or instead of, those illustrated in FIG. 3, and/or may include more than one of any or all of the illustrated elements, processes and devices.

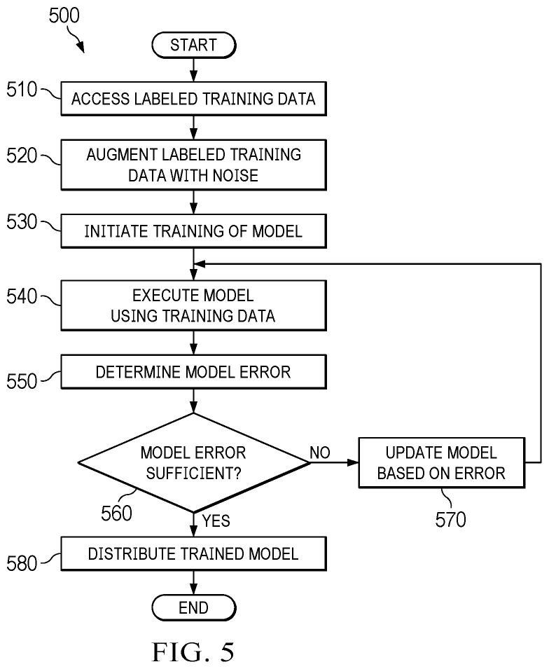

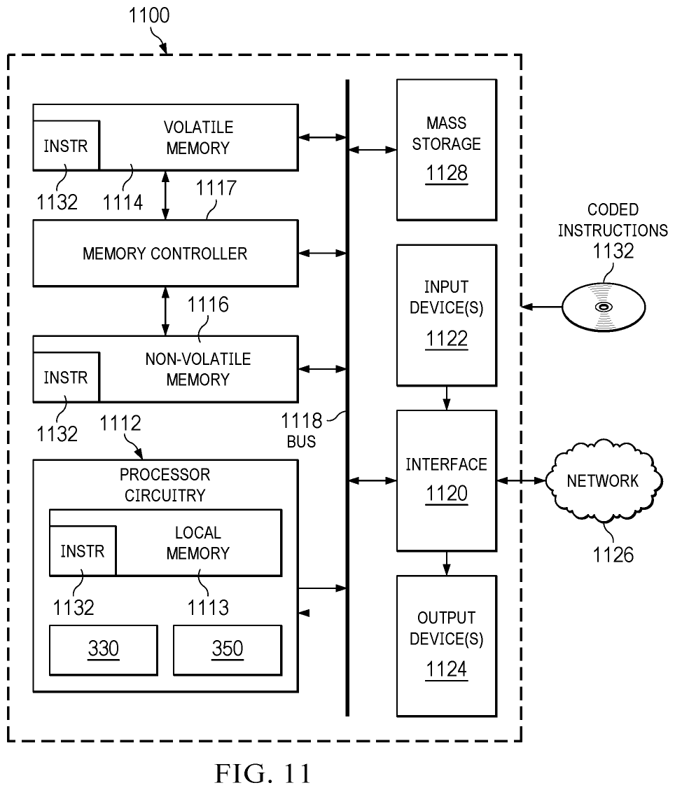

Flowchart(s) representative of example machine readable instructions, which may be executed by programmable circuitry to implement and/or instantiate the arc detection circuitry 220 of FIG. 2 and/or representative of example operations which may be performed by programmable circuitry to implement are shown in FIGS. 4 and/or 6. Flowchart(s) representative of example machine readable instructions, which may be executed by programmable circuitry to implement and/or instantiate the model trainer circuitry 310 of FIG. 3, are shown in FIG. 5. The machine readable instructions may be one or more executable programs or portion(s) of one or more executable programs for execution by programmable circuitry such as the programmable circuitry 1012, 1112 shown in the example processor platform 1000, 1100 discussed below in connection with FIG. 10 or 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4, 5, and/or 6, many other methods of implementing the example arc detection circuitry 220 or the example model trainer circuitry 310 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, Csharp, Perl, Python, JavaScript, HyperText Markup Language (HTML), Structured Query Language (SQL), Swift, etc.

As mentioned above, the example operations of FIGS. 4, 5, and/or 6 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations that may be executed, instantiated, and/or performed by example programmable circuitry to implement the arc detection circuitry of FIG. 2 to perform arc detection using a machine learning model. The example machine-readable instructions and/or the example operations 400 of FIG. 4 begin when the example sampling circuitry 230 samples a monitored circuit. (Block 410). The example monitored circuit may be, for example, the power conversion circuit 210, the load 215, or any other circuit that is to be monitored.

In the illustrated example of FIG. 4, the sampling circuitry 230 monitors voltage levels of the monitored circuit. However, any other electrical characteristic of the monitored circuit may also or alternatively be recorded. In the illustrated example of FIG. 4, the sampling circuitry 230 operates at a frequency of 3 kHz. Such a frequency is lower than the frequency of the prior art systems. Because of the lowered frequency, computing resources required to analyze the data are reduced, enabling multiple monitored circuits to be monitored at once, enabling low-power computing circuitry to be used to analyze the sampled data, etc.

The example sampling circuitry 230 stores the sampled data in the sampled data memory 240. (Block 420). The sampled data may be stored in any arrangement including, for example, a circular buffer. The example model executor circuitry 250 determines whether the amount of data stored in the sample data memory 240 is sufficient for performing analysis. (Block 430). In examples described herein, the model executor circuitry 250 determines that sample data is sufficient when at least seven hundred and fifty samples are stored in the sample data memory. At a sampling frequency of 3 kHz, these 750 samples represent approximately 250 ms of sample data that will be analyzed by the model executor circuitry. However, any other threshold may alternatively be used.

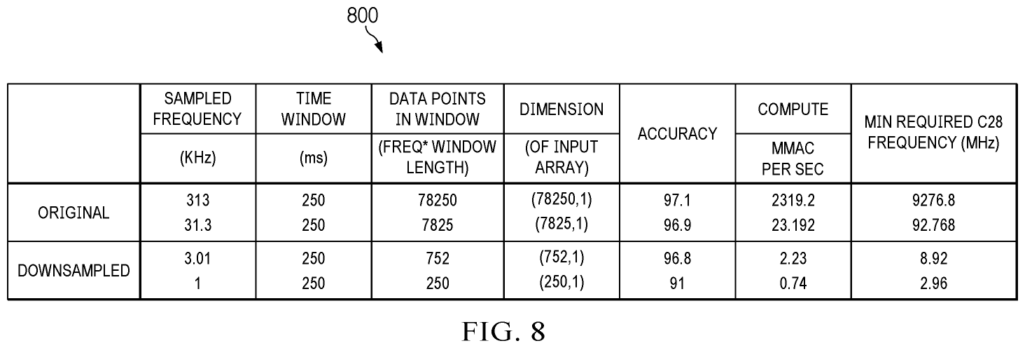

As explained below in connection with FIG. 8, using a down sample sampling frequency of 3 kHz and a 250 ms time window results and a 96.8% detection accuracy while utilizing 10% of the compute resources had a sampling frequency of 31.3 kHz been used. Such an approach, therefore, allows for multiple simultaneous channels to be monitored. Moreover, while windows of 250 ms are described herein, other sampling windows may alternatively be used. For example, using the example approaches described herein, sampling windows as short as 15 ms have been shown to produce accurate results. Further reductions in the size of the sampling window may still be achieved using the example approaches described herein.

If the example model executor circuitry 250 determines that the amount of sample data is not sufficient for analysis (e.g., block 430 returns a result of NO), the example sampling circuitry 230 continues to sample the monitored circuit. If the example model executor circuitry 250 determines that the amount of sample data is sufficient (e.g., block 430 returns a result of YES), the example model executor circuitry 250 executes the machine learning model stored in the model memory 255 using the sampled data. (Block 440).

When executing machine learning model using the sampled data, the example model executor circuitry 250 may prepare the sampled data by selecting a subset of the data stored in the sampled data memory 240. This subset may represent, for example, a most recent sampling window (e.g., the most recent seven hundred and fifty samples). In such an example, the sampled data memory 240 may store more samples than used by the model executor circuitry 250 when executing machine-learning model. For example, the sample data memory 240 may store one hundred thousand samples, whereas only the most recent seven hundred and fifty samples are used when executing the model. Those additional samples that are not used when executing the model may be useful when attempting to retrain the model using local data.

The example arc alert circuitry 270 reviews the result of the execution of the machine learning model to determine whether the result indicates that an arc has occurred. (Block 450). In examples described herein, the model executor circuitry 250 may output a result in the format of a numeric value representing a likelihood that an arc has occurred. The example arc alert circuitry 270 may evaluate that output against a threshold to determine whether to report that an arc has occurred. In such an example, the threshold may be set to allow an operator (e.g., a user) to allow for tuning of the sensitivity of the detection of whether an arc has occurred. In some other examples, the model executor circuitry 250 may output a binary value indicating whether the arc has occurred or not. Such a binary value may be evaluated by the arc alert circuitry 270 to determine whether the result indicates that the arc has occurred.

If the example arc alert circuitry 270 determines that the results of the execution of model indicates that the arc has occurred (e.g., block 450 returns a result of YES), the example arc alert circuitry 270 outputs an indication of the arc. (Block 460). The output of the indication of the arc may be provided to, for example, other circuitry to enable a remediating action to be taken (e.g., to shut down the monitored circuit, to reset the monitored circuit, etc.). In some examples, the indication of the arc is provided to an operator to allow the operator to intervene.

The example model executor circuitry 250 then determines whether to perform additional training. (Block 470). As described above, such traditional training may be enabled based on a variety of conditions. For example, such additional training may be performed on a periodic basis (e.g., after a threshold number of samples have been collected, after a threshold amount of time has elapsed, etc.), on an a-periodic basis (e.g., in response to a user request, in response to execution of the model indicating a low level of confidence in a result, etc.), or on both the a-periodic basis and the periodic basis. For example, the model executor circuitry 250 may be configurable to maintain a count of the number of samples collected and/or an elapsed time. The model executor circuitry 250 may be configurable to compare the count/time to a threshold value and initiate the additional training in response to the comparison. In this manner, the count/time may represent an amount of samples since a prior re-training, an amount of time since a prior re-training, etc.

As another example, the model executor circuitry 250 may be configurable to receive a software/firmware update, which may include an indication that additional training should be performed. The model executor circuitry 250 may be configurable to perform additional training in response to receiving the software/firmware update and/or determining that the software/firmware update includes the indication that additional training should be performed.

In some examples, a confidence score may additionally or alternatively be generated as part of the attempt to detect whether an arc has occurred. For example, the model executor circuitry 250 may generate both an indication (e.g., a value) representing a likelihood that an arc has occurred, as well as a confidence in the likelihood value. As an example, the model executor circuitry 250 may generate a value indicating a high likelihood that an arc has occurred, but also generate a low confidence in the generation of the high likelihood. In such an example, the model executor circuitry 250 may compare the confidence value to a confidence threshold to determine whether to perform additional re-training (e.g., in order to raise the confidence of future arc detections).

Moreover, in some examples, an instruction from a remote/external source (e.g., a cloud-based computing service, the model trainer circuitry, etc.) may cause the model executor circuitry 250 to determine that re-training is to be performed. For example, instead of receiving the software/firmware update as noted above, an update instruction may be received from the remote/external source to cause the model executor to perform re-training. Alternatively, the instruction received from the remote/external source may update configuration parameters (e.g., a count threshold, a time threshold, a confidence, etc.) used by the model executor circuitry 250 to determine whether to perform the re-training.

If no additional training is to be performed (e.g., block 470 returns a result of NO), the example sampling circuitry 230 continues to sample the monitored circuit, so that subsequent electrical arcs can be detected. (Block 410). If the example model executor circuitry 250 determines that additional training is to be performed (e.g., block 470 returns a result of YES), the example re-trainer circuitry 280 performs subsequent training of the model using data stored in the sampled data memory. (Block 480). An example approach for retraining of the model is described below in connection with FIG. 6. After retraining of the model is complete, the example sampling circuitry 230 continues to sample the monitored circuit.

While in the illustrated example of FIG. 4 the sampling of the monitored circuit and analysis of the collected samples is illustrated in a serial fashion, in some examples, the sampling and storage of monitored data may be performed in parallel with the analysis of the stored data. Furthermore, the retraining of the machine learning model may be performed in parallel with both of these processes (e.g., the sampling and analysis).

FIG. 5 is a flowchart representative of example machine readable instructions and/or example operations that may be executed, instantiated, and/or performed by example programmable circuitry to implement the model trainer circuitry of FIG. 3 to train and distribute the machine learning model to the arc detection circuitry of FIG. 2.

The example machine-readable instructions and/or the example operations 500 of FIG. 5 begin when the example trainer circuitry 330 accesses training data. (Block 510). Training data includes a plurality of windowed time sequences, and labels corresponding to whether an arc occurred in the context of the corresponding windowed sequence. The training data is accessed from, in some examples, the arc detection circuitry 220 reporting such windowed samples via the model update circuitry 260 to the model trainer circuitry 310 for storage in the training data memory 340.

The example trainer circuitry 330 augments the labeled training data with noise. (Block 520). The added noise improves results in improved model accuracy, as the noise-augmented training data more closely resembles various samples that may occur in practice. The example trainer circuitry 330 initiates training of a model that is stored in the trainer model memory 320. (Block 530). Training is performed by the example trainer circuitry 330 executing the model using the training data (Block 540), and evaluating an amount of error. (Block 550).

The example trainer circuitry 330 determines whether the amount of error is sufficient. (Block 560). For example, model error may be considered sufficient when it is less than a threshold amount of acceptable error (e.g., less than 1% error, less than 5% error, etc.). If the model error is not sufficient (e.g., block 560 returns a result of NO), the example trainer circuitry 330 updates the model based on the amount of detected error. (Block 570). The example trainer circuitry 330 then executes the updated model (block 540) and again determines the amount of error. (Block 550). This process continues until an acceptable amount of model error is achieved (e.g., until block 560 returns the result of YES). In some examples, other conditions may be utilized to determine whether to and training including, for example, when a threshold number of training iterations (sometimes known as epochs) have occurred, when a threshold amount of time has elapsed since the beginning of training, etc.

The example model distributor circuitry 350 distributes the model to the arc detection circuitry 220. (Block 580). The example model update circuitry 260, upon receiving the updated model from the model distributor circuitry 350, may store the updated model in the model memory 255 for subsequent use by the model executor circuitry 250.

In examples described herein, the model trainer circuitry 310 of FIG. 3 is implemented at a computing device separate from the arc detection circuitry 220. In this manner, higher power computing devices may be utilized to perform the training of the machine learning model, while lower power computing devices may be used to execute the trained model. Because training is a computationally intensive task, it is generally best reserved for devices having additional compute resources. However, in some examples, the ability to communicate updated models to the arc detection circuitry 220 (e.g., which may be embedded in an end-user device) may be limited. Moreover, the end-user device in which the arc detection circuitry 220 is implemented may age differently than other end-user devices. To that end, is advantageous to enable the arc detection circuitry 220 to perform local retraining of the machine learning model. However, because such retraining is compute-resource intensive, some example approaches described herein limit the retraining of the local machine learning model by the re-trainer circuitry 280 to classification layers of the machine learning model (e.g., as opposed to feature detection layers). Such an approach reduces the computational complexity of performing retraining. An example approach for local re-training is described below in connection with FIG. 6.

FIG. 6 is a flowchart representative of example machine readable instructions and/or example operations that may be executed, instantiated, and/or performed by example programmable circuitry to implement the arc detection circuitry of FIG. 2 to perform additional local training of the machine learning model. FIG. 6 is an example of the training that can occur in block 480 shown in FIG. 4.

The example process 600 of the illustrated example of FIG. 6 begins when the example re-trainer circuitry 280 is instructed by the model executor circuitry 250 to initiate re-training of the model. (Block 610). The re-training may be instructed as a result of a YES determination at block 470 of FIG. 4. In this manner, the example process 600 of FIG. 6 corresponds to block 480 of FIG. 4. The example re-trainer circuitry 280 causes the model executor circuitry 250 to execute the model stored in the model memory 255 using local training data stored in the sample data memory 240. In examples described herein, the data stored in the sample data memory 240 is presumed to represent normal operation of the monitored circuit. As a result, the training data stored in the sample data memory may be labeled as not being representative of arcing. However, in some examples, if arcing had previously been detected by the arc detection circuitry 220, such data may be stored in the sample data memory and be labeled as representative of arcing. Using data that is representative of local conditions enables the mole to evolve over time to more accurately detect arcing in a monitored circuit. The example re-trainer circuitry 280 determines an amount of model error. (Block 630). The example re-trainer circuitry 280 determines whether the amount of model error is sufficient. (Block 640). For example, model error may be considered to be sufficient when the detected amount of error is less than a threshold amount of acceptable error (e.g., less than 1% error). If the model error is not sufficient (e.g., block 640 returns a result of NO, indicating that the error exceeds the threshold amount of acceptable error), the example re-trainer circuitry 280 updates a portion of the model based on the amount of detected error. (Block 650).

In the illustrated example of FIG. 6, the re-trainer circuitry 280 updates a portion of the model based on the error. For example, the example re-trainer circuitry 280 may update classification layers of the machine learning model, as opposed to updating other layers (e.g., layers related to feature detection). Using such an approach reduces the computational complexity of updating model parameters, such that retraining can be performed on lower power computing devices, such as the example arc detection circuitry 220.

Example approaches described herein do not need to re-train based on labeled data that represents arcing. Instead, just having data of normal operation is sufficient for re-training of the model. In some examples, an auto-encoder approach is used as part of this re-training. In other words, unsupervised learning may be utilized as part of the re-training process.

Auto-encoders are a type of artificial neural network that can be used to train and retrain machine learning models, particularly in situations where data is limited or noisy. An auto-encoder approach utilizes an encoder and a decoder, which work together to learn a compressed representation of the input data and then reconstruct it as closely as possible from this representation.

In the context of the re-trainer circuitry 280 of FIG. 2, auto-encoders can be employed for retraining when additional training is needed using local data. This could occur if accuracy or confidence in the current model predictions are not sufficient. The encoder would take the input data (sampled from a monitored circuit) and compress it into a latent representation, while the decoder attempts to reconstruct the original data as closely as possible based on this compressed information.

During retraining with an auto-encoder, the parameters (e.g., weighting values) of the model are adjusted so that the reconstruction error is minimized. This process helps the model learn from noisy or limited training data and improve its performance in detecting arcs. Once re-training is complete, sampling and analysis can resume at block 410 (FIG. 3), with the updated model now better equipped to identify arc occurrences based on collected data.

After updating the model, the example re-trainer circuitry 280 causes the updated model to be executed by the model executor circuitry 250, and again determines the amount of error. (Block 630). This process continues until an acceptable amount of model error is achieved (e.g., until block 660 returns a result of YES). The updated model is then stored in the model memory 255 by the re-trainer circuitry 280 for subsequent use by the model executor circuitry 250. (Block 660). The example process 600 of FIG. 6 then terminates, but may be re-executed at a later time to, for example, update the local model to account for changing local conditions.

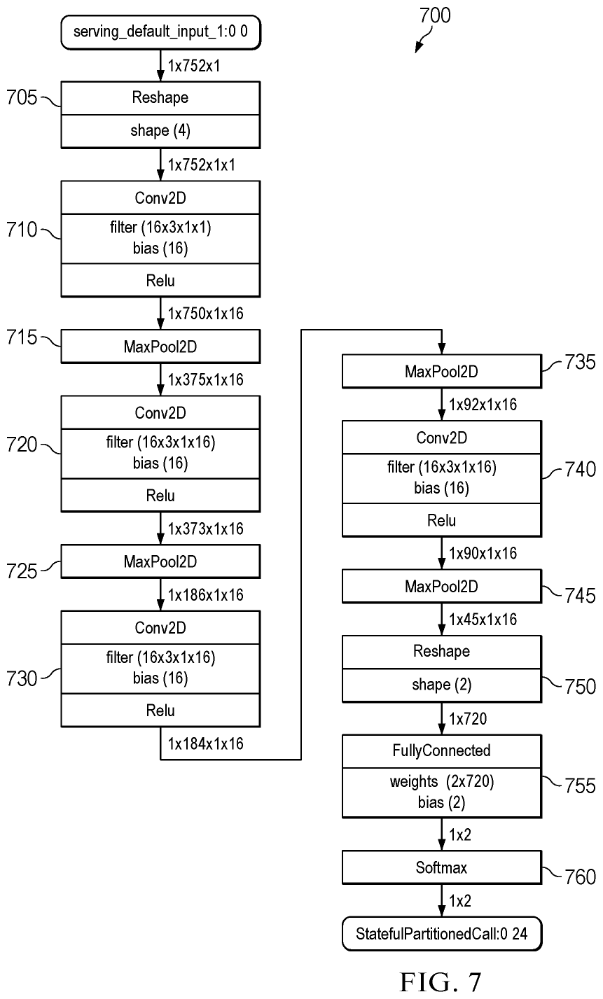

FIG. 7 is a diagram illustrating an example architecture 700 of the machine learning model used by the arc detection circuitry of FIG. 2. The example architecture 700 of the illustrated example of FIG. 7 includes a first layer 705, a second layer 710, a third layer 715, a fourth layer 720, a fifth layer 725, a sixth layer 730, a seventh layer 735, an eighth 740, a ninth layer 745, a tenth layer 750, an eleventh layer 755, and a twelfth layer 760. Architecture 700 may be a scaled down neural network that can run on a low-power edge device, as compared to a cloud-based neural network. While in the illustrated example of FIG. 7, the example architecture includes twelve layers, any other number of layers may also or alternatively be used. Moreover, the example architecture may utilize any other types of layers arranged in any other fashion.

In the illustrated example of FIG. 7, the example layers receive an input from a prior layer and provide an output to a subsequent layer. The first layer 705 is a reshaping layer that reshapes the input to form its output. The example second layer 710 is a two-dimensional convolution layer. The third layer 715 is a two-dimensional max pooling layer. The fourth layer 720 is a two-dimensional convolution layer. In this manner, the machine learning model includes a plurality of two-dimensional convolution layers. The fifth layer 725 is a two-dimensional max pooling layer. The sixth layer 730 is a two-dimensional convolution layer. The seventh layer 735 is a two-dimensional max pooling layer. The eighth layer 740 is a two-dimensional convolution layer. The ninth layer 745 is a two-dimensional max pooling layer. The tenth layer 750 is a reshaping layer. The eleventh layer 755 is a fully connected layer. The twelfth layer 760 is a soft max layer.

The example eleventh layer 755 and the example twelfth layer 760 represent classification layers that are useful for creating an output classification result. The first through tenth layers 705, 710, 715, 720, 725, 730, 735, 740, 745, 750 represent feature detection layers that enable detection of features in the monitored data. For example, the example eleventh layer 755 may include a fully connected neural network having weighted connections, which receives as input values generated by the first through tenth layers that represent the features of samples and generates as output values based on the input and weights of the connections. The twelfth layer 760 may then apply a Softmax function to the output to generate a value (e.g., a percentage value) representing an arc detection result.

In the illustrated example of FIG. 7, the first layer receives an input (e.g., a tensor, a sample, an input, a data sample) having an input size of seven hundred and fifty two data points. In examples disclosed herein, the sampling frequency may be dynamically scaled to achieve a desired time window. For example, a 30 ms time window may result in a sampling frequency of approximately 25 kHz to achieve the seven hundred and fifty two data points used as an input. In another example, a sampling frequency of approximately 7.5 kHz may be used with a time window of 100 ms, a sampling frequency of approximately 5 kHa may be used with a time window of 150 ms, a sampling frequency of approximately 3 kHz may be used with a time window of 250 ms, etc. In this manner, any sampling frequency and time window may be used.

FIG. 8 is a table illustrating differences between sampled and down-sampled approaches. FIG. 8 includes the results of simulations performed by the inventors. The example table 800 of FIG. 8 includes columns representing sampled frequencies, time windows, a resulting number of data points, and dimensions that are used in analysis of sampled data. Additionally, columns representing accuracy, compute resources used, and minimum frequencies used in testing the example approaches described herein are shown. In the illustrated example of FIG. 8, a row including original sampling frequencies is shown. At an original sampling frequency of 313 kHz, a time window representing 250 ms includes 78250 samples, and resulted in an accuracy of 97.1%. Similar accuracy was achieved when using a sampling frequency of 31.3 kHz (i.e., at 10% of the sampling frequency of the prior example). Example downsampling factors include ten, one hundred, and one thousand (e.g., from 1 MHz to 100, 10, or 1 kHz).

The example table 800 of FIG. 8 includes a row including down-sampled sampling frequencies. In particular, a sampling frequency of 3.01 kHz is illustrated which, when using a time window representing 250 ms, results in 752 samples being processed. Accuracy of 96.8% is still achieved, while reducing the computational requirements to approximately 10% of the number of operations used when operating at a sampling frequency of 31.3 kHz. At even lower sampling frequencies (e.g., at 1 kHz), detection accuracy begins to degrade (e.g., 91% accuracy at a 1 kHz sampling rate). This high level of accuracy was unexpected using a relatively simple neural network on a low-power edge device. Thus, it is possible to use down-sampling to reduce the size of training data while still maintaining accuracy at approximately the same level.

In practice, an edge device based on a microcontroller operating in the range of 100-240 MHZ (such as the C2000™ microcontroller from Texas Instruments) is capable of monitoring one circuit when operating at a sampling rate of 31.3 kHz. In contrast, the same microcontroller, when operated at a sampling frequency of 3.01 kHz, can monitor ten monitored circuits simultaneously, while maintaining approximately the same level of detection accuracy (e.g., within 1% arc detection accuracy).

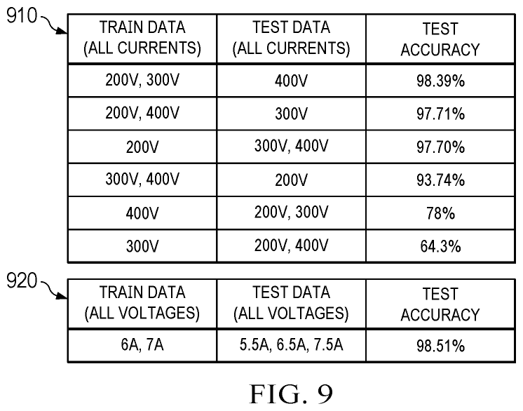

FIG. 9 is an illustration including tables representing performance statistics when the machine learning model utilized by the arc detection circuitry of FIG. 2 is trained using various training data. A first table 910 represents training an arc detection machine learning model using data acquired at relatively lower voltage levels and testing it using data acquired at relatively higher voltage levels, whereas a second table 920 represents training and testing an arc detection machine learning model at varying current levels. A first column of the first table 910 identifies voltage levels that were used in training data. A second column of the first table 910 identifies voltage levels that were used in test data (e.g., to validate the accuracy of a model trained using the training data represented by the first column). A third column of the first table 910 represents the resulting test accuracy.

Sequences at lower voltage applications have a higher signal-to-noise ratio compared to higher voltage applications, which means noise will be relatively high in comparison to signals. To train the model effectively on such noisy data, the training data is augmented with noise during training. This enables the model to learn more from these samples and perform well at even other different voltage levels such as higher voltage use case scenarios.

Example approaches described herein were utilized to test multiple different scenarios. For example, the model was trained on different input voltages, but shown only some voltages for testing its performance. In the first table 910, it is observed that 200V data has a very noisy signature due to arc energy being relatively higher as compared to other voltage applications like 300V and 400V. Intuitively, if 200V arc signatures are included in training, the model can learn even noisy signals, leading to better performance.

The third row of the first table 910 demonstrates this point, using just 200V data for training, the model performs well on 300V and 400V datasets (despite not having seen those input voltages in the training data).

In the second table 920, the model was trained on each of the above voltages (e.g., 200V, 300V, and 400V), but only some currents (e.g., 6 A and 7 A). The test performance on other current applications (e.g., 5.5 A, 6.5 A, and 7.5 A) shows a generalizability of 98.5% accuracy across many other application scenarios.

FIG. 10 is a block diagram of an example programmable circuitry platform 1000 structured to execute and/or instantiate the example machine-readable instructions and/or the example operations of FIGS. 4 and/or 6 to implement the arc detection circuitry 220 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example sampling circuitry 230, the example model executor circuitry 250, the example model update circuitry 260, the example arc alert circuitry 270, and the example re-trainer circuitry 280.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware according to any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, may include a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 4 and/or 6, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example programmable circuitry platform 1100 structured to execute and/or instantiate the example machine-readable instructions and/or the example operations of FIG. 5 to implement the model trainer circuitry 310 of FIG. 3. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example trainer circuitry 330 and the example model distributor circuitry 350.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware according to any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, may include a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 5, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1012 of FIG. 10. Alternatively, the block diagram of FIG. 12 may represent an example implementation of the programmable circuitry 1112 of FIG. 11. In this example, the programmable circuitry 1012 of FIG. 10 or the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 4, 5, and/or 6 to effectively instantiate the circuitry of FIGS. 2 and/or 3 as logic circuits to perform operations corresponding to those machine-readable instructions. In some such examples, the circuitry of FIG. 2 is instantiated by the hardware circuits of the microprocessor 1200 in combination with the machine-readable instructions. In some such examples, the circuitry of FIG. 3 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 4, 5, and/or 6.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1014, 1016 of FIG. 10, the main memory 1114, 1116 of FIG. 11). Higher levels of memory in the hierarchy may exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer-based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1012 of FIG. 10 or, alternatively, the 1112 of FIG. 11. In this example, the programmable circuitry 1012 or the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 4, 5, and/or 6 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4, 5, and/or 6. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4, 5, and/or 6. As such, the FPGA circuitry 1300 may be configured and/or structured to effectively instantiate some or all of the operations/functions corresponding to the machine readable instructions of the flowchart(s) of FIGS. 4, 5, and/or 6 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 4, 5, and/or 6 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 4, 5, and/or 6 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may also or alternatively be present such as a GPU, an XPU, etc., that can be programmed to perform other operations.

Although FIGS. 12 and 13 illustrate two example implementations of the programmable circuitry 1012 of FIG. 10 or the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1012 of FIG. 10 or the programmable circuitry 1112 of FIG. 11 may also be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 4, 5, and/or 6 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 4, 5, and/or 6, and/or an ASIC may be configured and/or structured to perform third operation(s)/function(s) corresponding to a third portion of the machine readable instructions represented by the flowcharts of FIGS. 4, 5, and/or 6.

Some or all of the circuitry of FIGS. 2 and/or 3 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIGS. 2 and/or 3 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 or 3 may be implemented within one or more virtual machines and/or containers executing on the microprocessor 1200 of FIG. 12.

In some examples, the programmable circuitry 1012 of FIG. 10 may be in one or more packages. Likewise, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1012 of FIG. 10 or the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

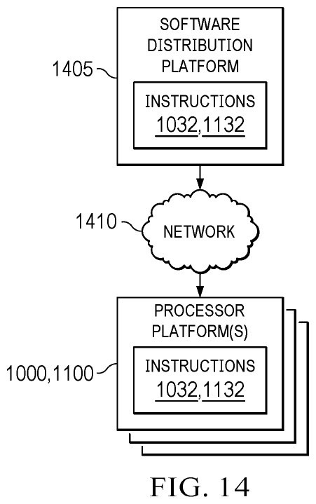

A block diagram illustrating an example software distribution platform 1405 to distribute software such as the example machine readable instructions 1032 of FIG. 10 or 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1032 of FIG. 10 or 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1032 of FIG. 10 or 1132 of FIG. 11, which may correspond to the example machine readable instructions of FIGS. 4, 5, and/or 6, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 or 1132 from the software distribution platform 1405. For example, the software, which may correspond to the example machine readable instructions of FIGS. 4 and/or 6, may be downloaded to the example programmable circuitry platform 1000, which is to execute the machine-readable instructions 1032 to implement the arc detection circuitry 220. Likewise, the software, which may correspond to the example machine readable instructions of FIG. 5, may be downloaded to the example programmable circuitry platform 1100, which is to execute the machine-readable instructions 1132 to implement the model trainer circuitry 310. In some examples, one or more servers of the software distribution platform 1405 periodically offer, transmit, and/or force updates to the software (e.g., the example machine readable instructions 1032 of FIG. 10, the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. Semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been described that enable efficient detection of arcing in a monitored circuit. Disclosed systems, apparatus, articles of manufacture, and methods improve the efficiency of using a computing device by utilizing machine learning techniques, which can operate based on data collected at lower sampling frequencies as compared with prior art approaches, while maintaining similar or improved levels of detection accuracy. Moreover, the examples described herein enable updates to be applied, resulting in arc detection circuitry that adjusts with changing conditions (e.g., ageing, degradation, etc.) of a monitored circuit. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
sampling circuitry configurable to generate data representing at least one of a voltage or a current of a monitored circuit;
memory; and
processing circuitry configurable to:
execute a machine learning model using the data to generate a classification representative of whether an arc has occurred within the monitored circuit;
cause output of a result of the classification of whether the arc has occurred within the monitored circuit;
record the data from the monitored circuit in the memory; and
perform additional training of the machine learning model based on the data recorded in the memory.

2. The apparatus of claim 1, wherein the data recorded in the memory is labeled as not including the arc.

3. The apparatus of claim 1, wherein to perform the additional training of the machine learning model, the processing circuitry is configurable to not alter at least a portion of the machine learning model as part of the additional training.

4. The apparatus of claim 1, wherein the processing circuitry is configurable to provide the data to model trainer circuitry for training of an updated machine learning model.

5. The apparatus of claim 4, wherein the processing circuitry is configurable to store the updated machine learning model in the memory.

6. The apparatus of claim 1, wherein the machine learning model includes a plurality of two-dimensional convolution layers followed by a fully connected layer.

7. The apparatus of claim 1, wherein the electrical arc is a direct current (DC) electrical arc.

8. The apparatus of claim 1, wherein to perform the additional training of the machine learning model, the processing circuitry is configurable to exclude feature detection layers of the machine learning model from the additional training.

9. The apparatus of claim 1, wherein the processing circuitry is configurable to generate the classification without performance of a Fourier transform.

10. The apparatus of claim 1, wherein the monitored circuit is a power conversion circuit.

11. The apparatus of claim 1, wherein the processing circuitry is to perform the additional training of the machine learning model in response to at least one of a user input, a number of samples in the data exceeding a threshold, or an instruction from an external source.

12. At least one non-transitory machine-readable medium comprising machine-readable instructions to cause at least one processor circuit to at least:
access data representing at least one of a voltage or a current of a monitored circuit;
execute a machine learning model using the data to generate a classification representative of whether an arc has occurred within the monitored circuit;
cause output of a result of the classification of whether the arc has occurred within the monitored circuit;
record the data from the monitored circuit; and
perform additional training of the machine learning model based on the recorded data.

13. The at least one non-transitory machine-readable medium of claim 12, wherein at least a portion of the machine learning model is not altered as part of the additional training.

14. The at least one non-transitory machine-readable medium of claim 12, wherein the machine-readable instructions are to cause one or more of the at least one processor circuit to provide the data to model trainer circuitry for training of an updated machine learning model.

15. The at least one non-transitory machine-readable medium of claim 14, wherein the machine-readable instructions are to cause one or more of the at least one processor circuit to store the updated machine learning model.

16. The at least one non-transitory machine-readable medium of claim 12, wherein the machine learning model includes a plurality of two-dimensional convolution layers followed by a fully connected layer.

17. The at least one non-transitory machine-readable medium of claim 12, wherein the arc is a direct current (DC) electrical arc.

18. The at least one non-transitory machine-readable medium of claim 12, wherein the machine-readable instructions are to cause one or more of the at least one processor circuit to perform the additional training of the machine learning model in response to an amount of time having elapsed without the determination that the arc has occurred within the monitored circuit.

19. A method comprising:
accessing data representing at least one of a voltage or a current of a monitored circuit;
executing a machine learning model using the data to generate a classification representative of whether an arc has occurred within the monitored circuit;
causing output of a result of the classification of whether the arc has occurred within the monitored circuit;
recording the data from the monitored circuit; and
performing, using at least one logic circuit, additional training of the machine learning model based on the recorded data.

20. The method of claim 19, wherein at least a portion of the machine learning model is not altered as part of the additional training.
